(19) United States
(12) Patent Application Publication
(10) Pub. No.: US 2024/0025154 A1
(43) Pub. Date: Jan. 25, 2024

(54) Laminated Windows

(71) Applicant: Apple Inc., Cupertino, CA (US)

(72) Inventors: David E. Kingman, San Francisco, CA (US); Albert J. Golko, Saratoga, CA (US); Dale N. Memering, New York, NY (US); Peter F. Masschelein, Campbell, CA (US)

(21) Appl. No.: 18/478,828

(22) Filed: Sep. 29, 2023

Related U.S. Application Data
(63) Continuation of application No. PCT/US2022/023537, filed on Apr. 5, 2022.
(60) Provisional application No. 63/172,317, filed on Apr. 8, 2021.

(51) Int. Cl. B32B 17/10; B32B 1/00; B60J 1/00

(52) U.S. Cl. CPC B32B 17/10036; B32B 1/00; B32B 17/10467; B32B 17/1055; B32B 17/10917; B32B 17/10889; B60J 1/001; B32B 2307/538; B32B 2605/08; B32B 2307/418

(57) ABSTRACT

A window in a system may have inner and outer window layers. The inner and outer window layers may be formed from molded glass plates. The inner window layer may have a molded convex surface formed by molding a first glass plate against a mold with a concave surface. The inner window layer may have an opposing non-molded surface that does not contact the mold during molding operations and is smoother than the molded convex surface. The outer window layer may have a molded concave surface formed by molding a second glass plate against a mold with a convex surface. The outer window layer may have an opposing non-molded surface that is not contacted by the mold during molding operations and is smoother than molded convex surface. A layer of polymer may join the inner and outer window layers with their molded surfaces facing each other.

This application is a continuation of international patent application No. PCT/US2022/023537, filed Apr. 5, 2022, which claims priority to U.S. provisional patent application No. 63/172,317, filed Apr. 8, 2021, which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A system such as a building or vehicle may have windows. The windows may include laminated windows formed by attaching inner and outer window layers together with a layer of polymer.

The inner and outer window layers in a window may be formed from molded glass plates. The inner window layer may have a molded convex surface formed by molding a first glass plate against a mold with a concave surface. The molding process may create textured surfaces.

A layer of polymer may join the inner and outer window layers. The refractive index of the polymer layer may match the refractive index of the molded glass plates to reduce reflections and to prevent light scattering due to roughness in the textured surfaces. Optical component layers may optionally be embedded in the layer of polymer.

### BRIEF DESCRIPTION OF THE DRAWINGS

FIG. 1 is a cross-sectional view of an illustrative system with a window in accordance with an embodiment.

FIGS. 2, 3, 4, and 5 are cross-sectional side views of illustrative window glass fabrication equipment in accordance with embodiments.

FIG. 6 is a side view of window glass processing equipment of the type that may be used to process glass layers with mating molded surfaces in accordance with embodiments.

FIG. 7 is a side view of illustrative lamination equipment being used to form a laminated window from glass layers of the type shown in FIG. 6 in accordance with an embodiment.

### DETAILED DESCRIPTION

Systems may be provided with windows. For example, a vehicle or other system may have glass windows. Laminated glass windows may be formed by attaching two or more glass layers together with adhesive. In some configurations, glass layers may be molded to form curved shapes prior to lamination.

The systems in which the windows are used may be buildings, vehicles, or other suitable systems. Illustrative configurations in which the system is a vehicle such as an automobile may sometimes be described herein as an example. This is merely illustrative. Windows may be formed in any suitable systems.

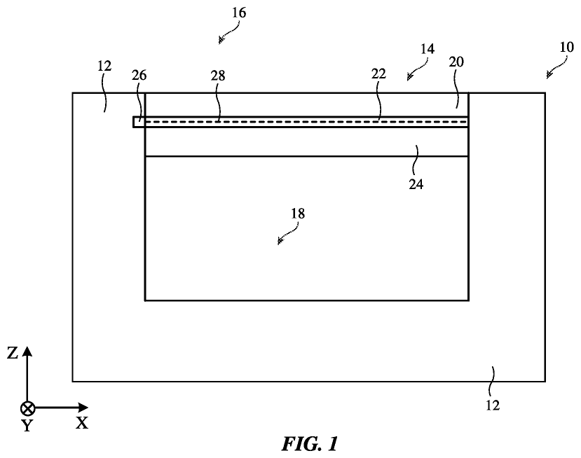

An illustrative system of the type that may include windows is shown in FIG. 1. System 10 may be a vehicle, building, or other type of system. In an illustrative configuration, system 10 is a vehicle. As shown in FIG. 1, system 10 may have support structures such as body 12. Body 12 may be a vehicle body that includes doors, trunk structures, a hood, side body panels, a roof, and/or other body structures. Body 12 may be configured to surround and enclose interior region 18. System 10 may include a chassis to which wheels are mounted, may include propulsion and steering systems, and may include other vehicle systems. Seats may be formed in interior region 18 of body 12. Window 14, which may be a vehicle window, and portions of body 12 may be used to separate interior region 18 of system 10 from the exterior environment (exterior region 16) that is surrounding system 10.

Windows such as window 14 may be coupled to body 12 and may be configured to cover openings in body 12. Motorized window positioners may be used to open and close windows 14, if desired. The windows in system 10 such as window 14 may include a front window mounted within an opening in body 12 at the front of a vehicle, a moon roof (sun roof) window or other window extending over some or all of the top of a vehicle, a rear window at the rear of a vehicle, and/or side windows on the sides of a vehicle. Window 14 may be flat (e.g., window 14 may lie in the X-Y plane of FIG. 1) or window 14 may have one or more curved portions (e.g., window 14 may have a curved cross-sectional profile and may be oriented to lie generally parallel to the X-Y plane so that a convex surface of window 14 faces outwardly in direction Z of FIG. 1). The area of each window 14 in system 10 may be at least 0.1 m², at least m², at least 1 m², at least 5 m², at least 10 m², less than 20 m², less than 10 m², less than 5 m², or less than 1.5 m² (as examples).

System 10 may include control circuitry and input-output devices. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or for gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices may be used to provide a user with haptic output, audio output, visual output (e.g., displayed content, light, etc.), and/or other suitable output. During operation, control circuitry in system 10 may gather user input, environmental information, and other information from sensors and/or other input-output devices and may control adjustable components in system 10 based on this gathered information.

Window 14 may be formed from one or more layers of transparent glass, clear polymer (e.g., polycarbonate, acrylic, etc.), polymer adhesive, and/or other layers. For example, window 14 may be formed from two glass layers or three glass layers laminated together with adhesive. The glass layers may be chemically or thermally tempered (e.g., to create compressive stress on the surfaces of the glass layers). In the illustrative configuration of FIG. 1, window 14 is formed from outer window layer 20 and inner window layer 24 (e.g., outer and inner structural glass layers and/or other layers of transparent material). The thicknesses of layers 20 and 24 may be, for example, 0.5 mm to 3 mm, at least 0.3 mm, at least 0.5 mm, less than 4 mm, less than 3 mm, or other suitable thickness. Outer layer 20 and inner layer 24 may be laminated together using a polymer layer such as interposed adhesive layer 22 (e.g., an adhesive layer with one surface bonded to the inwardly facing surface of outer window layer 20 and an opposing surface bonded to the outwardly facing surface of inner window layer 24). Adhesive layer 22 may have a refractive index that is matched (e.g., within 0.1, within 0.07, within 0.05, or within 0.03) to that of layers 20 and 24. Examples of polymers that may be used for forming adhesive layer 22 include thermoplastic polyurethane, ethylene-vinyl acetate, and polyvinyl butyral. Layer 22 may, if desired, include polymer configured to provide sound dampening (e.g., a soft polyvinyl butyral sublayer or other acoustic film embedded within layer 22).

Outer window layer 20 may be formed from a single layer of structural window glass or may include multiple sublayers such as one or more layers of glass, optically clear adhesive, and/or polymer films. Inner window layer 24 may similarly be formed from a single layer of structural window glass or may include multiple sublayers such as one or more layers of glass, optically clear adhesive, and/or polymer films. In the present example, layers 20 and 24 are glass layers formed from molded plate glass.

If desired, optional fixed and/or adjustable optical components may be incorporated into window 14. As shown in FIG. 1, for example, one or more optical components such as optical layer 28 may be incorporated into window 14 (e.g., one or more layers such as layer 28 may be embedded in adhesive layer 22). Each layer 28 may be a fixed and/or adjustable optical layer providing fixed and/or adjustable amounts of opacity, polarization, reflection, color cast, haze, and/or other optical properties. In an illustrative configuration, layer 28 may be a light guide that receives light from light source 26. Light source 26 may, as an example, provide visible light that is guided across window 14 within the light guide by total internal reflection. Light-scattering structures may be provided in window 14 to extract some of the guided light from the light guide (e.g., inwardly to produce illumination for interior region 18 and/or outwardly). Arrangements for window 14 that include an illuminated light guide and/or one or more additional fixed and/or adjustable optical layers may also be used. Configurations for window 14 in which optical components such as optical component layer 28 of FIG. 1 have been omitted may sometimes be described herein as an example.

The windows in system 10 may be completely planar (e.g., the inner and outer surfaces of window 14 may be flat) and/or some or all of the windows in system 10 may have surface curvature. The inner and outer surfaces of each window may as an example, have compound curvature (e.g., non-developable surfaces characterized by curved cross-sectional profiles taken along the X and Y directions of FIG. 1) and/or may have developable surfaces (surfaces with zero Gaussian curvature that can be flattened without distortion). Curved window shapes may be formed by heating glass until the glass is sufficiently soft to mold. If desired, heated window glass may be at least partly shaped under force of gravity. To obtain desired curved window shapes, additional force such as pressure from a mold die may be used in molding the inner and outer structures of the windows.

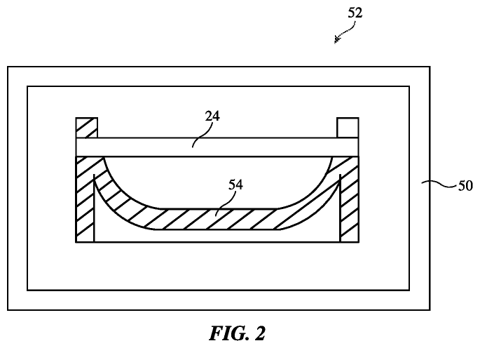

Consider, as an example, the illustrative glass molding operations shown in FIGS. 2, 3, 4, and 5. During glass molding operations, molding equipment may be used to mold sheets of plate glass into shapes with curved cross-sectional profiles. Flat glass sheets (e.g., sheets of soda-lime silica glass stock) may be molded into desired shapes to form outer window layers such as outer window layer 20 of FIG. 1 and inner window layers such as inner window layer 24 of FIG. 1. These molded window layers may be characterized by curved cross-sectional profiles and may have surfaces that are free of compound curvature (e.g., the window layers may have only developable surfaces), may have surfaces that are free of developable surface areas (e.g., the window layers may have surfaces with only compound curvature), and/or may have both one or more areas characterized by developable surfaces and one or more areas characterized by compound curvature.

As shown in FIG. 2, a flat layer of glass for forming inner window layer 24 may be heated within furnace 50 of molding equipment 52. Equipment 52 may include a mold with a desired curved shape such as mold 54. Mold 54 may be formed from a material such as graphite that can withstand high temperatures. Vacuum pressure may be applied through openings in mold 54 and/or through porous mold materials (e.g., porous graphite). Upon application of heat with furnace 50, the glass of layer 24 will soften.

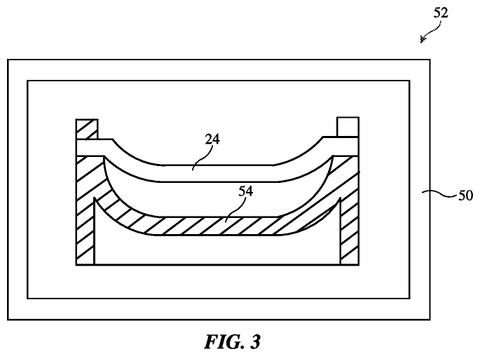

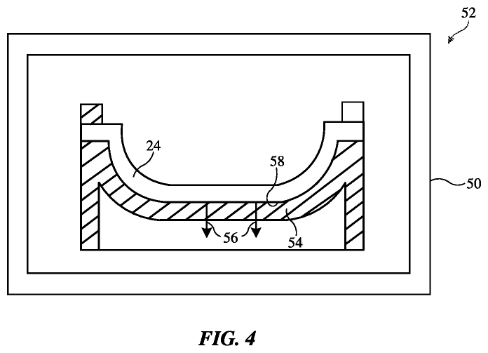

After softening layer 24 with heat, layer 24 may sag under force of gravity to form the partially deformed shape of FIG. 3. Vacuum may then be applied to the mold-facing surface of layer 24 as shown by arrows 56 of FIG. 4. The applied vacuum pulls layer 24 downward against the curved surface of mold 54, forming glass layer 24 into its desired shape.

This process results in a shape for inner window layer 24 that is characterized by a convex outwardly facing surface (surface 58). There may be surface texture (roughness) on surface 58 due to the contact between the convex molded surface of layer 24 and the opposing concave surface of mold 54 (e.g., due to roughness on the concave mold surface that is imprinted into the molded surface).

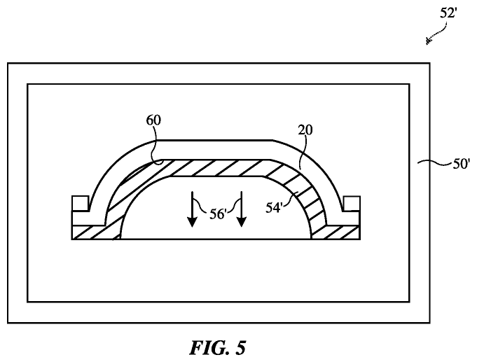

Outer window layer 20 may be formed using a mold with a convex surface. As shown in FIG. 5, for example, outer window layer 20 (e.g., a layer of plate glass) may be placed in furnace 50′ of molding equipment 52′ and molded against mold 54′. Layer 20 is initially heated in furnace 50′ to soften layer 20. Gravity may cause the softened glass of layer 20 to sag as described in connection with layer 24 in equipment 52 of FIG. 3. Layer 20 may then be molded against the exposed convex surface of mold 54′ by applying vacuum 56′ to layer 20. Mold 54′ may be formed from a porous material such as porous graphite and/or may have vacuum openings to help allow vacuum 56′ to pull layer 20 against the exposed convex surface of mold 54′. The pressure applied by the vacuum causes concave surface 60 of layer 20 to take on the shape of mold 54′, thereby forming glass layer 20 into a desired final shape. As with the surface of layer 24 that contacted mold 54 (surface 58), surface 60 of layer 20 may be rough due to the contact between concave surface 60 and the corresponding convex rough exposed surface of mold 54′.

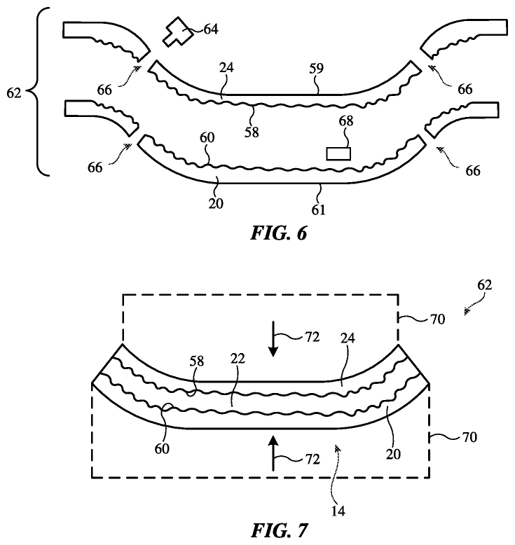

The shape of the convex surface of mold 54′ of FIG. 5 may be matched to the shape of the concave surface of mold 54 of FIG. 4. As a result, concave surface 60 of outer layer 20 will mate with corresponding convex surface 58 of inner window layer 24, as shown in FIG. 6. Concave surface 60 is a molded surface that has molded surface roughness due to contact with mold 54′ of FIG. 5. Opposing surface 61 is a non-molded surface that is not pressed against the mold and is therefore characterized by less surface roughness than molded surface 60. Convex surface 58 is a molded surface that has molded surface roughness due to contact with mold 54 of FIG. 4. Opposing surface 59 is a non-molded surface that is characterized by less surface roughness than molded surface 58. (Although sometimes described in the context of using molds that create mold-roughened surfaces 58 and 60 on matching concave and convex sides of molded glass layers, it will be appreciated that other glass shaping processes such as press bending may be used in forming layers 20 and 24 that have roughened surfaces.)

To prepare window layers 20 and 24 for lamination, processing equipment 62 may be used to trim the edges of layers 20 and 24 and may optionally treat surfaces 58 and 60. As an example, equipment 62 may include cutting tool 64. Tool 64 may be a computer-controlled cutter such as a laser cutter, grinding tool, or waterjet cutter having electrically controlled positioners. These positioners may be controlled to form cuts 66 around the perimeter of layer and around the perimeter of layer 24 (e.g., perimeter cuts that form a desired outline for window 14. The outline of window 14 may be, as an example, rectangular, triangular, oval, circular, etc., may have straight and/or curved edge segments, and/or may have other suitable outline shapes.

If desired, tool 68 may be optionally used to apply chemical etchant (e.g., to chemically treat surface 58 and/or surface 60 by chemically etching surface 58 and/or surface 60 to enhance smoothness), tool 68 may be used to mechanically polish surface 58, and/or surface 60 (e.g., by moving a polishing head across surfaces 58 and/or 60), and/or tool 68 may use a combination of chemical and mechanical polishing techniques to help reduce surface roughness. The use of chemical etchant (and, if desired, polishing) may help widen micro-cracks that might otherwise remain in surfaces 58 and 60. By widening cracks in surfaces 58 and 60 (e.g., by using chemical etchant to chemically etch surfaces 58 and 60), these cracks may become sufficiently large to receive polymer (e.g., adhesive 22 and/or other polymer, liquid polymer that is subsequently cured, thermoplastic polyurethane, ethylene-vinyl acetate, polyvinyl butyral, and/or other polymer materials) during subsequent lamination operations (e.g., trapped air bubbles or other voids may be reduced by chemically etching surfaces 58 and 60 to open up cracks that might otherwise be sufficiently narrow to promote void formation when polymer is applied to surfaces 58 and 60).

If desired, the use of surface treatment tools such as tool 68 may be avoided (e.g., to help reduce processing complexity).

The molding process used to mold layers 20 and 24 may introduce surface distortion of 1-7%, 5-9%, less than 10%, less than 8%, less than 5%, at least 2%, at least 4%, at least 6%, or other surface distortion. During molding, the contact between surfaces 58 and 60 and the corresponding surfaces of molds 54 and 54′ may introduce surface roughness to surfaces 58 and 60. As an example, mold-roughened surfaces such as surfaces 58 and 60 may be characterized by a roughness value of about 100 nm Ra (e.g., at least 10 nm Ra, at last 20 nm Ra, at least 40 nm Ra, at least 80 nm Ra, or at least 160 nm Ra, less than 1000 nm Ra, less than 500 nm Ra, less than 250 nm Ra, less than 140 nm Ra, less than 70 nm Ra, 25-400 nm Ra, 50-200 nm Ra, or other surface roughness value). Rough surfaces such as these have potential to create undesired haze in window 14 due to light scattering from surface features.

The thickness and refractive index of adhesive layer 22 may be configured to satisfactorily attach layers 20 and 24 together while eliminating or at least reducing haze in window 14 due to the surface roughness of layers 20 and 24 (e.g., to a value of haze below 2%, below 1%, or below 0.5%, as examples). FIG. 7 shows how adhesive layer 22 may be formed between layers 20 and 24, as layers 20 and 24 are laminated together using lamination equipment in processing equipment 62 (e.g., vacuum lamination equipment). As shown in FIG. 7, liquid adhesive may be dispensed between surfaces 58 and 60 and pressure may be applied by equipment 62 (e.g., by pressing layers 20 and 24 together in directions 72 using lamination dies 70. The liquid polymer forming layer 22 may be cured by application of heat, light (e.g., ultraviolet light), catalyst, etc.

To avoid undesired light scattering due to molded surface roughness associated with surfaces 58 and 60, the thickness of layer 22 may be sufficient to separate the glass of surfaces 58 and 60 from direct contact with each other and the refractive index of layer 22 may be matched to that of layers 20 and 24. As an example, the thickness of layer 22 may be 0.076 mm, at least 0.030 mm, less than 0.14 mm, 0.03-0.1 mm, etc. and the refractive index of layer 22 may be matched to that of layers 20 and 24 within 0.2, within 0.1, or within 0.05.

The refractive index of layers 20 and 24 may be about 1.4-1.5. For example, layer 20 and layer 24 may each have refractive index values of at least 1.3, at least 1.35, at least 1.4, at least 1.45, less than 1.6, less than 1.5, less than 1.45, 1.35-1.55, 1.4-1.5, 1.4-1.5, 1.45-1.55, 1.4-1.6, 1.3-1.6, 1.35-1.55, or other suitable refractive index values. Layers 20 and 24 may have the same refractive index value or the refractive index values of layers 20 and 24 may be different. In an illustrative configuration, layers 20 and 24 share a common refractive index value. To help avoid light reflections at the interface between layer 22 and layer 24 and to help avoid light reflections at the interface between layer 20 and layer 22 and to help avoid haze from light-scattering due to the molded surface roughness of surfaces 58 and 60, the refractive index of layer 22 may match that of layers 20 and 24 within 0.2, within 0.15, within 0.1, within 0.05, or other suitable matching amount. Closely matched refractive index values (e.g., values where the refractive index of layer 22 deviates above or below that of layers 20 and 24 by less than 0.1 or less than 0.05) may exhibit less light reflection than less closely matched refractive index values (e.g., values where the refractive index of layer 22 is larger or smaller than the index of layers 20 and 24 by at least 0.1). In general, however, any suitable refractive index value may be used for the polymer of layer 22.

If desired, one or more optical component layers such as layer 28 of FIG. 1 may be embedded in layer 22. Following formation of window 14 of FIG. 7, window 14 may be installed in an opening of body 12 (see, e.g., FIG. 1).

In accordance with an embodiment, a system is provided that includes a body; and a window in the body includes an inner window layer having a convex surface with molded surface roughness; an outer window layer having a concave surface with molded surface roughness; and polymer between the concave and convex surfaces that attaches the inner and outer window layers.

In accordance with another embodiment, the inner window layer is a glass vehicle window layer.

In accordance with another embodiment, the outer window layer is a glass vehicle window layer.

In accordance with another embodiment, the convex and concave surfaces are each characterized by a surface roughness of 50-150 nm Ra.

In accordance with another embodiment, the polymer includes a polymer selected from the group consisting of: thermoplastic polyurethane, ethylene-vinyl acetate, and polyvinyl butyral.

In accordance with another embodiment, the inner window layer has a non-molded surface opposing the convex surface and the outer window layer has a non-molded surface opposing the concave surface.

In accordance with another embodiment, the non-molded surface opposing the convex surface has less surface roughness than the convex surface and the non-molded surface opposing the concave surface has less surface roughness than the concave surface.

In accordance with another embodiment, the outer window layer has a surface with compound curvature.

In accordance with another embodiment, the system includes an optical component layer embedded in the polymer.

In accordance with another embodiment, the inner window layer is a layer of a glass, the outer window layer is a layer of the glass, and the glass has a refractive index value of 1.35-1.55.

In accordance with another embodiment, the polymer has a refractive index that differs from the refractive index value of the glass by less than 0.1.

In accordance with an embodiment, a vehicle is provided that includes a vehicle body; and a vehicle window configured to cover an opening in the vehicle body, the vehicle window has first and second structural window layers attached to each other by a layer of polymer, the first structural window layer has a mold-roughened surface and a non-mold-roughened surface, the second structural window layer has a mold-roughened surface and a non-mold-roughened surface, and the mold-roughened surface of the first structural window layer faces the non-mold-roughened surface of the second structural window layer.

In accordance with another embodiment, the mold-roughened surface of the first structural window is convex and the mold-roughened surface of the second structural window layer is concave.

In accordance with another embodiment, the mold-roughened surfaces are characterized by surface roughness of 50 nm to 200 nm Ra.

In accordance with another embodiment, the polymer layer includes a polymer layer selected from the group consisting of: a thermoplastic polyurethane polymer layer, an ethylene-vinyl acetate polymer layer, and a polyvinyl butyral polymer layer.

In accordance with another embodiment, the vehicle includes an optical component layer embedded in the polymer layer.

In accordance with an embodiment, a vehicle window is provided that includes inner and outer glass layers, the inner glass layer has opposing first and second surfaces, the outer glass layer has opposing third and fourth surfaces, the first surface has a surface roughness of 50 nm to 200 nm Ra, and the third surface has a surface roughness of 50 nm to 200 nm Ra; and polymer between the inner and outer glass layers that is attached to the first surface and that is attached to the third surface.

In accordance with another embodiment, the inner glass layer has a curved cross-sectional profile and the outer glass layer has a curved cross-sectional profile.

In accordance with another embodiment, the first surface includes a molded surface, the second surface includes a non-molded surface, the third surface includes a molded surface, and the fourth surface includes a non-molded surface.

In accordance with another embodiment, the inner and outer glass layers have a common refractive index value that is between 1.35 and 1.55, the polymer layer has a refractive index within 0.1 of the refractive index value, at least part of the first surface is convex, and at least part of the third surface is concave.

The foregoing is merely illustrative and various modifications can be made to the described embodiments. The foregoing embodiments may be implemented individually or in any combination.

What is claimed is:

1. A system, comprising:
a body; and
a window in the body, comprising;
an inner window layer having a convex surface with molded surface roughness;
an outer window layer having a concave surface with molded surface roughness; and
polymer between the concave and convex surfaces that attaches the inner and outer window layers.

2. The system defined in claim 1 wherein the inner window layer is a glass vehicle window layer.

3. The system defined in claim 2 wherein the outer window layer is a glass vehicle window layer.

4. The system defined in claim 3 wherein the convex and concave surfaces are each characterized by a surface roughness of 50-150 nm Ra.

5. The system defined in claim 4 wherein the polymer comprises a polymer selected from the group consisting of: thermoplastic polyurethane, ethylene-vinyl acetate, and polyvinyl butyral.

6. The system defined in claim 4 wherein the inner window layer has a non-molded surface opposing the convex surface and wherein the outer window layer has a non-molded surface opposing the concave surface.

7. The system defined in claim 6 wherein the non-molded surface opposing the convex surface has less surface roughness than the convex surface and wherein the non-molded surface opposing the concave surface has less surface roughness than the concave surface.

8. The system defined in claim 3 wherein the outer window layer has a surface with compound curvature.

9. The system defined in claim 1 further comprising an optical component layer embedded in the polymer.

10. The system defined in claim 1 wherein the inner window layer is a layer of a glass, wherein the outer window layer is a layer of the glass, and wherein the glass has a refractive index value of 1.35-1.55.

11. The system defined in claim 10 wherein the polymer has a refractive index that differs from the refractive index value of the glass by less than 0.1.

12. A vehicle, comprising:
a vehicle body; and
a vehicle window configured to cover an opening in the vehicle body, wherein the vehicle window has first and second structural window layers attached to each other by a layer of polymer, wherein the first structural window layer has a mold-roughened surface and a non-mold-roughened surface, wherein the second structural window layer has a mold-roughened surface and a non-mold-roughened surface, and wherein the mold-roughened surface of the first structural window layer faces the non-mold-roughened surface of the second structural window layer.

13. The vehicle defined in claim 12 wherein the mold-roughened surface of the first structural window is convex and wherein the mold-roughened surface of the second structural window layer is concave.

14. The vehicle defined in claim 13 wherein the mold-roughened surfaces are characterized by surface roughness of 50 nm to 200 nm Ra.

15. The vehicle defined in claim 14 wherein the polymer layer comprises a polymer layer selected from the group consisting of: a thermoplastic polyurethane polymer layer, an ethylene-vinyl acetate polymer layer, and a polyvinyl butyral polymer layer.

16. The vehicle defined in claim 15 further comprising an optical component layer embedded in the polymer layer.

17. A vehicle window, comprising:
inner and outer glass layers, wherein the inner glass layer has opposing first and second surfaces, wherein the outer glass layer has opposing third and fourth surfaces, wherein the first surface has a surface roughness of 50 nm to 200 nm Ra, and wherein the third surface has a surface roughness of 50 nm to 200 nm Ra; and
polymer between the inner and outer glass layers that is attached to the first surface and that is attached to the third surface.

18. The vehicle window defined in claim 17 wherein the inner glass layer has a curved cross-sectional profile and wherein the outer glass layer has a curved cross-sectional profile.

19. The vehicle window defined in claim 18 wherein the first surface comprises a molded surface, wherein the second surface comprises a non-molded surface, wherein the third surface comprises a molded surface, and wherein the fourth surface comprises a non-molded surface.

20. The vehicle window defined in claim 19 wherein the inner and outer glass layers have a common refractive index value that is between 1.35 and 1.55, wherein the polymer layer has a refractive index within 0.1 of the refractive index value, wherein at least part of the first surface is convex, and wherein at least part of the third surface is concave.
